(19) United States
(12) Patent Application Publication
(10) Pub. No.: US 2007/0299664 A1
(43) Pub. Date: Dec. 27, 2007

(54) Automatic Text Correction

(75) Inventors: Jochen Peters, Aachen (DE); Evgeny Matusov, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,674

(22) PCT Filed: Sep. 28, 2005
(86) PCT No.: PCT/IB05/53193

§ 371 Date: Mar. 21, 2007

(30) Foreign Application Priority Data
Sep. 30, 2004 (EP) 04104789.5

(51) Int. Cl. G06F 3/16

(52) U.S. Cl. 704/235; 704/E15.043

(57) ABSTRACT

The present invention provides a method of generating text transformation rules for speech to text transcription systems. The text transformation rules are generated by means of comparing an erroneous text generated by a speech to text transcription system with a correct reference text. Comparison of erroneous and reference text allows to derive a set of text transformation rules that are evaluated by means of a strict application to the training text and successive comparison with the reference text. Evaluation of text transformation rules provides a sufficient approach to determine which of the automatically generated text transformation rules provide an enhancement or degradation of the erroneous text. In this way only those text transformation rules of the set of text transformation rules are selected that guarantee an enhancement of the erroneous text. In this way systematic errors of an automatic speech recognition or natural language process system can be effectively compensated.

The present invention relates to the field of automatic correction of erroneous text by making use of a comparison with a corresponding correct reference text.

Text documents that are generated by a speech to text transcription process are typically not error free due to various aspects. Even though state of the art automatic speech recognition (ASR) and natural language processing (NLP) systems already provide appreciable performance with respect to speech to text transcription and automatic insertion of non spoken punctuations, automatic text segmentation, insertion of headings, automatic formatting of dates, units, abbreviations, . . . , the resulting text may still suffer from systematic errors. For example, an automatic speech recognition system may misinterpret a particular word as a similar sounding word. Also, entries in a lexicon or dictionary used by an automatic speech recognition system might be subject to an error. Hence, the automatic speech recognition or speech transcription system may systematically generate a misspelled word when this particular dictionary entry has been recognized in a provided speech.

In general, all ASR and NLP systems are error prone. In particular, sophisticated speech to text converters often exhibit high error rates for complex tasks, for example when a multitude of formatting operations have to be performed that might be handicapped by recognition errors of an ASR system. Even though these facts are well known, there does not yet exist a universal approach to detect and to eliminate systematic errors of ASR and NLP systems.

The document US 2002/0165716 discloses techniques for decreasing the number of errors when consensus decoding is used during speech recognition. Generally, a number of corrective rules are applied to confusion sets that are extracted during real time speech recognition. The corrective rules are determined during training of the speech recognition system, which entails using many training confusion sets. A learning process is used that generates a number of possible rules, called template rules, that can be applied to the training confusion sets. The learning process also determines the corrective rules from the template rules. The corrective rules operate on the real time confusion sets to select hypothesis words from the confusion sets, where the hypothesis words are not necessarily the words having the highest score.

In the disclosure US 2002/0165716 corrective rules are determined by making use of many training confusion sets that are converted from word lattices by means of a consensus decoding. The word lattices are in turn created by a decoder making use of entries of the recognizer's lexicon. In this way determination and deriving of corrective rules is based on the speech recognition system's lexicon. In this way no words outside the recognizer's lexicon are feasible, hence the entire process of determining corrective rules is based on words that are already known in the speech recognition system. Further, each confusion set is composed of a recognized word and a set of alternative words which can replace the recognized word, i.e. the set provides the chance to replace a single word by another single word potentially including an “empty word” corresponding to a deletion.

The present invention therefore aims to provide a universal approach to detect and to eliminate systematic errors of any type of a given text, that might be generated by means of an ASR or NLP system irrespectively of ASR or NLP specific training data, lexica or other predetermined text databases.

The present invention provides a method of generating text transformation rules for an automatic text correction by making use of at least one erroneous training text and a corresponding correct reference text. The inventive method makes use of comparing the at least one erroneous training text with the correct reference text and to derive a set of text transformation rules by making use of deviations between the training text and the reference text. These deviations are detected by means of the comparison between the erroneous training text and the correct reference text. After deriving a set of text transformation rules, the set of text transformation rules is evaluated by applying each transformation rule to the training text. Depending on this evaluation of the text transformation rules at least one of the set of evaluated text transformation rules is selected for the automatic text correction.

The erroneous training text might be provided by means of an automatic speech recognition system or by any other type of speech to text transformation system. The reference text in turn corresponds to the training text and should be error free. This correct reference text might be manually generated by a proofreader of a recognized text of an ASR and/or NLP system. Alternatively, an arbitrary reference text, typically in electronic form might be provided to an inventive text correction system, i.e. a system that is applicable to perform the inventive method, and the erroneous training text might be generated by inputting the reference text as speech into an ASR and/or NLP system and by receiving the transcribed text as erroneous training text generated by the ASR and/or NLP system.

The method of generating text transformation rules makes further use of detecting deviations between the reference text and the erroneous training text. Detection of deviations is by no means restricted to a word to word comparison but may also include a phrase to phrase comparison, wherein each phrase has a set of words of the text. Moreover, deviations between the training text and the reference text may refer to any type of conceivable error that a speech to text transcription system may produce. In this way any type of error of the erroneous training text will be detected and classified.

Classification of detected errors typically refer to substitution, insertion or a deletion of text. For example, each word of the training text might be assigned to a corresponding word of the reference text and may therefore marked as correct when the two words exactly match. In case that a particular word has been misinterpreted by the. ASR or NLP system, e.g. the system transcribed “bone” instead of “home”, the word “home” may be marked as being substituted by the word “bone”. Other scenarios, where a multitude of words has been transcribed into one word or vice versa, the detected deviation might be marked by means of a deletion or insertion, typically in combination with a substitution. This may for example be applied when e.g. “a severe” has been misinterpreted as “weird”.

Each detected deviation is typically assigned to a corresponding word of the correct reference text. Alignment of text portions of the training text to the corresponding corrected text portions can be performed by making use of some standard techniques, such as minimum editing distance or the Levenshtein alignment. Based on the assignment or alignment between erroneous text portions and corresponding correct text portions and an appropriate classification, text transformation rules can be generated. For the above given example, where “a severe” has been misinterpreted by “weird” a text transformation rule may specify that in general the word “weird” has to be replaced by “a severe”. However this text transformation rule may not correspond to a systematic error of the ASR or NLP system and when consistently applied to a text, each occurrence of the word “weird” might be replaced by “a severe”, irrespective whether for other occurrences the word “weird” has been transcribed correctly or not.

Generation of text transformation rules can be performed analogue to transformation based learning (TBL) that is known in the framework of deriving transformation rules for correcting tagging processes which assign some information of grammatical or semantic content to a stream of words. With the present invention, transformation based learning is modified and adapted in order to assign reference text to erroneous text portions.

To distinguish between repeated, systematic and incidental, irreproducible errors, the text transformation rules that have been automatically generated have to be evaluated. Hence, it has to be determined, which of the generated text transformation rules correspond to systematic errors of the speech to text transcription procedure. This evaluation is typically performed by applying each one of the generated text transformation rules to the training text and to perform a subsequent comparison with the reference text in order to determine whether a text transformation rule provides elimination of errors or whether its consequent application introduces even more errors into the training text. Even though a generated text transformation rule may eliminate one particular error, it may also introduce numerous additional errors into correct text portions of the training text.

The evaluation of the set of text transformation rules allows to perform a ranking of the text transformation rules for intuitively selecting only those text transformation rules that lead to an improvement of the training text when applied to the training text. Hence only those text transformation rules of the automatic generated set of text transformation rules are selected and provided to the automatic text correction for detecting and eliminating systematic errors of an ASR and/or NLP system.

According to a preferred embodiment of the invention, deriving of text transformation rules is performed with respect to assignments between text regions of the training and the reference text. These text regions specify contiguous and/or non-contiguous phrases and/or single or multiple words and/or numbers and/or punctuations. In this way the inventive method is universally applicable to any type of text fragments or text regions irrespective whether they represent a word, a punctuation, a number or combinations thereof. These assignments or alignments between text regions of the training and the reference text might be performed by a word to word mapping, i.e. replacing an erroneous word by its corrected reference counterpart.

Since word to word assignments may often be ambiguous, the method is by no means restricted to word to word mappings. Moreover, assignments between the training and the reference text may be performed on a larger scope. Hence a text having a multitude of words might be partitioned into error free and erroneous regions. Based on this type of partition, mappings might be performed between complete error regions allowing to reduce ambiguities and to learn longer ranging phrase to phrase mappings. Such a phrase to phrase mapping may for example be expressed as a mapping between an erroneous text portion “the patient has weird problem” by the correct expression “the patient has a severe problem”.

Additionally, assignments may also be performed on the basis of partial error regions specifying a sub-region of an error region. This is preferably applicable when short ranging errors of an error region may reappear in other contexts. For example, a partial error region may specify some grammatically wrong expression, such as “one hours”.

Upon detection of a deviation or a mismatch between training text and reference text not only a single text transformation rule but a plurality of overlapping text transformation rules may be generated. Upon local detection of a deviation and generation of a particular text transformation rule, the method has no knowledge of the global performance or quality of the generated text transformation rule. Therefore, it is advantageous to generate a plurality of rules that might be applicable to a detected error. For example, if the sentence “the patient have a severe problem” has been transcribed as “the patient has weird problem”, a whole set of text transformation rules might be generated. A very simple word to word transformation rule may specify to replace “weird” by “severe”. Another text transformation rule may specify to replace “weird” by the phrase “a severe”. Still another text transformation rule may specify to substitute “has weird” by “has a severe” and so on.

Obviously, some of these automatically generated text transformation rules may not improve but merely degrade the quality of a text when strictly applied to the text. Therefore, the evaluation of the set of text transformation rules has to be applied in order to find reasonable text transformation rules of the generated set of text transformation rules.

According to a further preferred embodiment of the invention, a text transformation rule comprises at least one assignment between a text region of the training text and a text region of the reference text and makes further use of an application condition specifying situations where the assignment is applicable. In this way a text transformation rule may specify to replace a distinct text region by a corrected text region only when an additional condition is fulfilled. This allows to make some text transformation rules specific enough to correct errors while leaving correct text unaffected.

For example simply introducing a comma between any two words or before any occurrence of the word “and” would certainly insert more inappropriate commas than introducing correct commas into the text. In this case the application condition might be expressed in form of an assertion that e.g. requires that the next word is “and” and that there exists a comma two positions before that “and” in order to insert some missing comma.

Moreover, the application condition may specify an exclusion that may disable the applicability of some text transformation rule. For example a text transformation rule may specify to replace “colon” by “:”. It is advantageous to inhibit application of this particular text transformation rule when the word “colon” is e.g. preceded by an article. Many more application conditions are conceivable and may even exploit word contexts that might be represented by word classes. Such a word class may define metric units for example and an application condition may specify to convert the word “one” by “1” if the next word is from a class metric unit. This is only a basic example, but application conditions may also make use of longer ranging contextual conditions that make use of text segmentation and topic labeling schemes.

According to a further preferred embodiment of the invention, evaluating of the set of text transformation rules makes use of separately evaluating each text transformation rule of the set of text transformation rules. This separate evaluation of a text transformation rule makes further use of an error reduction measure and comprises the steps of: applying the text transformation rule to the training text, determining a number of positive counts, determining a number of negative counts and deriving an error reduction measure on the basis of position and negative counts.

Application of a text transformation rule to the training text refers to a strict application of the text transformation rule and provides a transformed training text. Both the initial and this transformed training text are then compared with the correct reference text in order to determine the performance of this particular text transformation rule. In this way it can be precisely determined how often the application of the text transformation rule provides elimination of an error of the initial training text. For each elimination of an error of the training text the positive count of the text transformation rule is incremented. In the same way the comparison between transformed training text and reference text allows to determine how often application of the text transformation rule provides generation of an error in the training text. In this case the number of negative counts is incremented.

Based on these numbers of positive and negative counts an error reduction measure can be derived. Typically, the error reduction measure can be obtained by subtracting the negative counts from the positive counts. If the result is positive the particular text transformation rule will generally provide an improvement on the training text. In the other case, when the result is negative, strict application of this distinct text transformation rule will have a negative impact on a text when applied by an automatic text correction system. Additionally, the error reduction measure might be scaled by some kind of error quantifier that specifies how many errors are produced or eliminated by a single application of this distinct text transformation rule. This allows to obtain a universal error reduction measure that can be used to compare the performance of the various text transformation rules.

In principle by making use of an error reduction measure for each text transformation rule, a selection of text transformation rules having a positive impact on a training text can already be performed. In this case possible interactions between various rules of the set of text correction rules are not taken into account. Since the various text transformation rules may overlap, i.e. they refer to the same or partially overlapping text regions, subsequent application of various rules to the same text region may in turn lead to a degradation of the text.

According to a further preferred embodiment of the invention, evaluating and deriving of the set of text transformation rules further comprises iteratively performing of an evaluation procedure. Here, in a first step a ranking of the set of text transformation rules is performed by making use of the rules error reduction measure. Then the highest ranked text transformation rule is applied to the training text in order to generate a first transformed training text. The highest ranked rule refers to that rule of the whole set of text transformation rules that provide a maximum enhancement and a minimum degradation of the text. Since application of this highest ranked text transformation rule affects the initial training text, all remaining rules have to be at least reevaluated and/or re designed in order to cope with the modified training text.

Generally, the ranking of the remaining rules may no longer be valid. Therefore, a second set of text transformation rules is derived on the basis of the reference text and the first transformed training text. Deriving of this second set of text transformation rules is typically performed analogue to the generation of the first set of text transformation rules, i.e. by comparing the first transformed training text with the reference text, detecting deviations between the two texts and generating appropriate text transformation rules.

After deriving this second set of text transformation rules, a second ranking is performed on the basis of this second set of text transformation rules and the first transformed training text. This ranking is performed analogue to the initial ranking of the set of text transformation rules, hence it makes use of error reduction measures for each rule of the second set of text transformation rules. Thereafter, the highest ranked rule of the second set of text transformation rules is applied to the first transformed training text in order to generate a second transformed training text. Thereafter, the entire procedure is repeatedly applied and a third set of text transformation rules is generated on the basis of a comparison between the second transformed training text and the original reference text. Preferably, this iterative procedure may be performed until the n-times transformed training text equals the reference text or until the n-times transformed training text does not show any improvement with respect to the (n−1)-times transformed training text. Typically, the highest ranked rule within each iteration is selected as a text transformation rule for the automatic text correction system.

By making use of this iterative procedure, interaction between the various text transformation rules is taken into account and provides a reliable approach to perform an evaluation and rule generation procedure. However, this iterative evaluation procedure might be computationally expensive and might therefore require inappropriate computation time and computation resources.

According to a further preferred embodiment of the invention, evaluation of the set of text transformation rules comprises discarding of a first text transformation rule of a first and a second text transformation rule of the set of text transformation rules if the first and second text transformation rule substantially refer to the same text regions of the training text. The first text transformation rule is discarded if the first text transformation rule has been evaluated worse than the second text transformation rule, i.e. the first rule's error reduction measure is worse than the second rule's error reduction measure. Discarding is by no means restricted to discard rules pair wise. Moreover, it is advantageous to arrange all rules referring to the same text region and to perform a ranking of those rules referring to the text region. Then, for each text region only that rule featuring the largest error reduction measure is selected and provided to the text correction system. In this way the iterative procedure does not have to be explicitly applied in order to find good rules even with respect to rule interactions.

According to a further preferred embodiment of the invention, deriving of the set of text transformation rules makes further use of at least one class of text units or “words” that is specific for a type of text error. Typically, such a class of text units, also denoted as a word class, refers to a grammar rule or some context specific rule. A word class may for example specify a class of metric units, such like meters, kilometers, millimeters. Advantageously a transformation rule may exploit such a word class in order to e.g. replace a written number by its number counterpart when followed by a metric expression specified by the word class. Other examples may refer to the class of indefinite articles, like “a, an, one” that may never be followed by a plural word like “houses, cars, pencils, . . . ”. Text transformation rules making use of word classes may also be implemented by making use of above described application conditions for text transformation rules.

According to a further preferred embodiment of the invention, text transformation rules themselves can be specified to transform some text region into another text region unless certain conditions are met which are typically indicative for an unintended transformation of a correct text region into an erroneous text region. In this way, text transformation rules may not only specify a substitution, insertion or deletion in a positive sense but also inhibit transformation of a text region that has a high probability of being correct.

According to a further preferred embodiment of the invention, evaluating and/or selecting of text transformation rules further comprises providing at least some of the set of text transformation rules to a user. The user then may manually evaluate and/or manually select any of the provided text transformation rules. In this way the critical task of evaluating and selecting of highly performing text transformation rules can be performed by means of interaction with a user. Typically, text transformation rules may be provided to the user by means of visualization, e.g. by visualizing the concrete substitution of a text transformation rule and by providing logic expressions specifying an application condition for the text transformation rule. The user may be provided with a set of conquering text transformation rules that may refer to e.g. the same text region. The user then may perform a choice of one of the provided alternative text transformation rules.

According to a further preferred embodiment of the invention, the erroneous training text is provided by an automatic speech recognition system, a natural language understanding system or generally by a speech to text transformation system. Hence, the inventive method is dedicated for detecting systematic errors of these systems on the basis of their textual output and a comparison with a corresponding correct reference text.

The inventive method further automatically generates text transformation rules that allow to compensate the detected systematic errors. Moreover, the inventive method generally allows to compare an erroneous text with a reference text irrespective of their origin. In this way the inventive method may even be applied in education programs where some trainee or student generates a potentially erroneous text and where the inventive method can be used to provide feedback to the student after correction of the text or after comparison of the text with a reference text.

In another aspect, the invention provides a text correction system that makes use of text transformation rules for correcting erroneous text. The text correction system is adapted to generate the text transformation rules by making use of at least one erroneous training text and a corresponding correct reference text. The inventive text correction system comprises means for comparing the at least one erroneous training text with the correct reference text, means for deriving a set of text transformation rules by making use of deviations between the training text and the reference text, whereby the deviations are detected by means of the comparison. The text correction system further comprises means for evaluating the set of text transformation rules by applying each transformation rule to the training text and means for selecting of at least one of the set of evaluated text transformation rules for the text correction system.

In still another aspect, the invention provides a computer program product for generating text transformation rules for an automatic text correction. The computer program product is adapted to process at least one erroneous training text and a corresponding correct reference text. The computer program product comprises program means that are operable to compare the at least one erroneous training text with the correct reference text and to derive a set of text transformation rules by making use of deviations between the training text and the reference text. Typically, these deviations are detected by means of the computer supported comparison. The program means of the computer program product are further operable to evaluate the set of text transformation rules by applying each transformation rule to the training text and to finally select at least one of the set of evaluated text transformation rules for the text correction system.

In still another aspect, the invention provides a speech to text transformation system for transcribing speech into text. The speech to text transformation system has a text correction module that makes use of text transformation rules for correcting errors of the text and having a rule generation module for generating the text transformation rules by making use of at least one erroneous training text that is generated by the speech to text transformation system and a corresponding correct reference text. The speech to text transformation system and in particular its rule generation module comprises a storage module for storing the reference and the training text, a comparator module for comparing the at least one erroneous training text with the correct reference text, a transformation rule generator for deriving a set of text transformation rules, an evaluator that is adapted to evaluate the set of text transformation rules by applying each transformation rule to the training text and finally a selection module for selecting of at least one of the set of evaluated text transformation rules for the text correction module.

According to a further preferred embodiment of the invention, the speech to text transformation system and/or the text correction system comprise a user interface for visualizing generated text transformation rules in combination with information of estimated or calculated error changes or error reduction measures per text transformation rule. The user interface comprises a selection tool that allows for sorting and/or selecting and/or discarding a distinct rule or a set of rules. Moreover, the user interface may also provide manual definition and generation of text transformation rules by the user. Hence, the user himself may define or specify an arbitrary rule. This user-defined rule may then be fed into the evaluator module and the user may be provided with feedback about the performance of this proposed rule. User-defined rules may also be included in the ranking with automatically generated rules whence statistical evidence and human intuition may be combined for maximal benefit.

Moreover, the user interface may visualize word classes in such a way, that the user can manually control and specify modifications of word classes, such as merging or splitting of word classes. Additionally, the user interface may graphically highlight regions in a modified text that were subject of application of a text transformation rule. Highlighting might be provided in combination with an undo function that allows for an easy compensation of modifications introduced by a certain rule.

According to a further preferred embodiment, a list of rules and conditions for their application is generated from the comparison of one or several training and reference texts. Instead of evaluating the rules on the data from which they were generated, they may be stored for later use. Thereafter, upon receiving training and reference texts from a specific user, all rules may be evaluated on the basis of these texts. This approach enables the user-specific selection of rules from a long list of previously generated and stored rules which may stem from a plurality of different users with different error characteristics. Generating rules from a larger data set beforehand may provide more rules—or improved conditions when to use or to inhibit some rule—than can be extracted from the often limited user-specific data alone. Furthermore, the time to generate rules in online systems can be reduced.

The invention therefore provides a method that is universally applicable to any two corresponding texts, one of which featuring a number of errors. The method and the text correction system can be universally implemented with speech to text transformation systems and allows to compensate systematic errors of these systems or at least to provide suggestions to a user how errors detected in a text can be eliminated for future applications of the speech to text transformation system, such like ASR and/or NLP.

It is further be noted that any reference signs in the claims are not to be construed as limiting the scope of the present invention.

In the following preferred embodiments of the invention will be described in greater detail by making reference to the drawings in which:

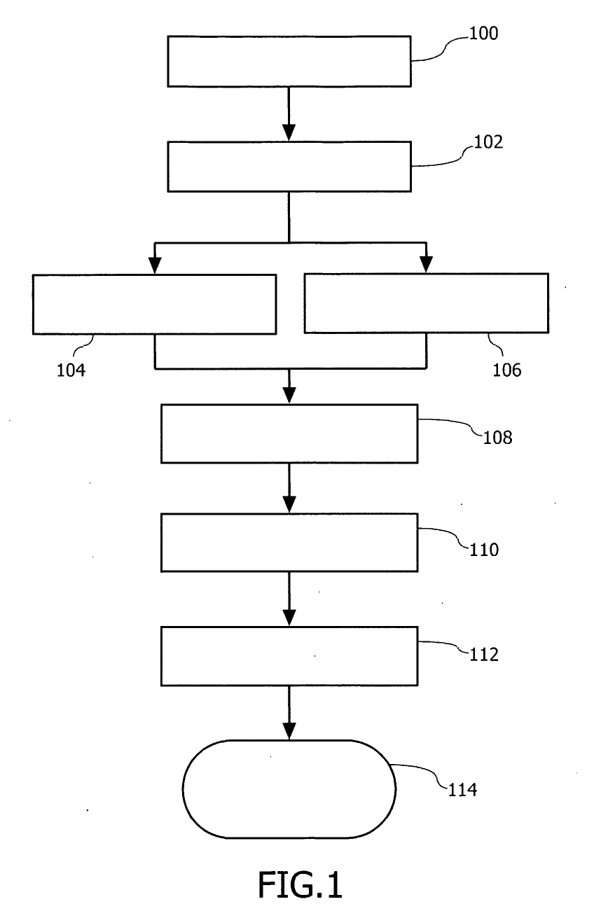

FIG. 1 shows a flowchart of the inventive method of generating text transformation rules,

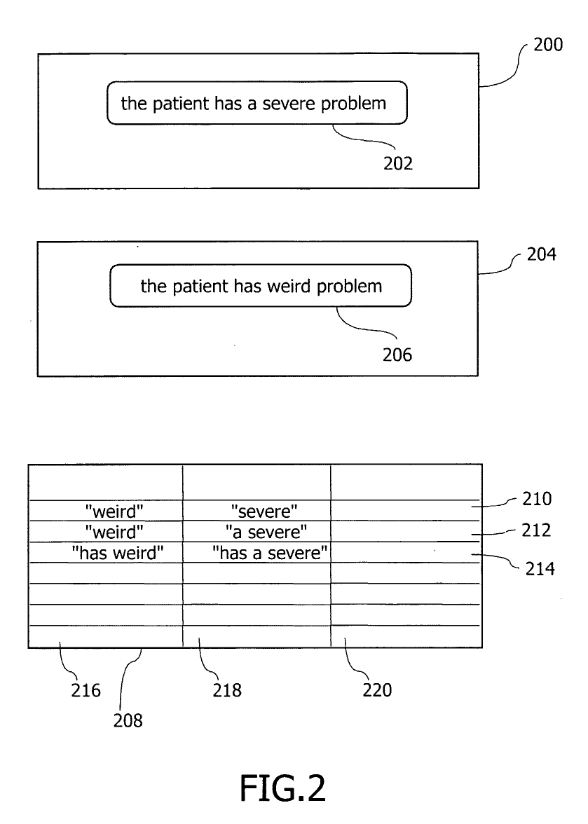

FIG. 2 illustrates a schematic block diagram of reference text, training text and a list of text transformation rules,

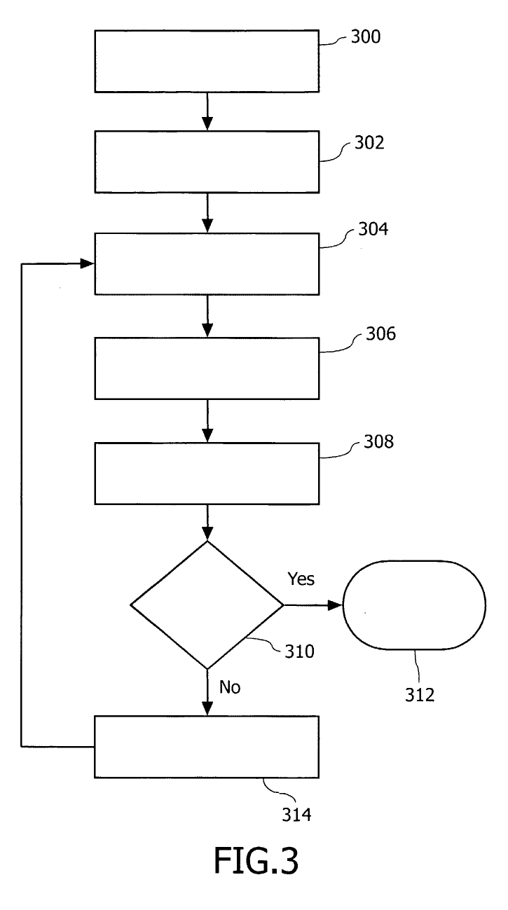

FIG. 3 shows a flowchart of iteratively evaluating text transformation rules,

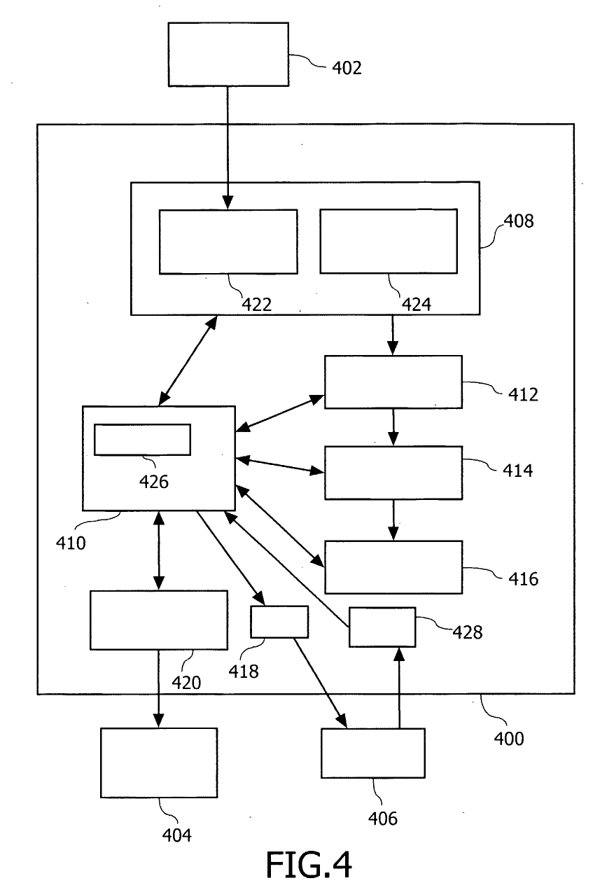

FIG. 4 shows a block diagram of a rule generation module for generating text transformation rules for an automatic text correction system.

FIG. 1 illustrates a flowchart of performing the inventive method of generating text transformation rules making use of at least one erroneous training text and a corresponding correct reference text. Typically, the reference text is already provided to an automatic text correction system and is stored in an appropriate memory. Then, in a first step 100 the erroneous text, also denoted as training text, is received and stored in an appropriate memory. In this way erroneous text and reference text are stored separately allowing for comparison and modification of the erroneous text.

Typically, the erroneous text is provided by an automatic speech recognition system and/or a natural language processing system or any other type of speech to text transformation system. After the erroneous text has been received in step 100, in a successive step 102, erroneous text and reference text are compared. This comparison can be based on either word to word comparison or on a comparison that is based on comparing entire text regions including a multitude of words, numbers, punctuations and similar text units. Advantageously, this comparison can be performed by means of a minimum editing distance and/or a Levenshtein alignment even providing a measure of a deviation between an erroneous text portion and a corresponding correct text portion.

On the basis of this comparison, a set of text assignments can be derived in step 104 as well as a set of assignment conditions can be derived in step 106. Text assignments may refer to any type of text modification that is necessary in order to transform an erroneous text region into its corresponding correct counterpart. In this way a text assignment may refer to an insertion, a deletion or a substitution. For example, a wrong expression like “the patient has weird problem” may be assigned to the correct expression of the reference text “the patient has a severe problem”.

Typically, for each detected deviation, a number of possible text assignments between erroneous text portions and corresponding correct text portions may be generated. Referring to the above mentioned example, substitutions “weird” to “severe” as well as “weird” to “a severe” and many others are conceivable. Additional to the text assignments, a set of assignment conditions for each text assignment may be derived in step 106. An assignment condition may specify that a particular text assignment has only to be applied when some specific assignment condition is fulfilled. When for example a text assignment specifies to insert a comma before the word “and”, the assignment condition may specify that the insertion specified by the text assignment is only applicable when two positions before occurrence of “and” a comma is given. Another example of text assignment might be given by replacing the word “colon” by the sign “:”. Here, the assignment condition may specify not to apply the text assignment if the preceding word is an article or belongs to a class of text elements or text regions such as “a, an, the”. Another inhibitive condition might be some higher level text segmentation which indicates that the current sentence belongs to e.g. some gastro-intestinal diagnosis.

The assignment conditions for text assignments or text mappings may be extracted by making use of statistic evaluation of the associated text mapping. Hence, by strictly applying a particular text assignment and determining whether the strict application of the text assignment eliminates or introduces an error, an assignment condition can be derived when taking into account the surrounding text portions of the text assignments. In the above example of mapping “the patient has weird problem” to “the patient has a severe problem”, the surrounding words of the central replacement of “weird” by “a severe” may be specified as a condition in a positive sense. Here, one possible condition can be stated as “the preceding word is ‘has’ or stems from some word class containing ‘has’”.

Of course, longer ranging dependencies including non-adjacent text regions, such as in the condition “two words before we must have a comma”, can also be directly extracted from the compared texts.

In principle, the derived text assignments generated in step 104 and the corresponding set of assignment conditions derived in step 106 are sufficient to specify a text transformation rule. In a simplest embodiment already by deriving text assignments, such like substitution, insertion and deletion might be sufficient to define a specific text transformation rule.

Advantageously, the various text transformation rules, i.e. a set of text transformation rules are derived and generated in step 108 by making use of the two preceding steps 104 and 106. In this way text assignments and assignment conditions are effectively merged. Once the text transformation rules have been generated in step 108, they are stored by some kind of storage. After deriving the set of text transformation rules in step 108, in a subsequent step, the entirety of text transformation rules has to be evaluated in order to select those text transformation rules that represent a systematic error of the speech to text transformation system that generated the erroneous text.

Evaluation of text transformation rules can be performed in a plurality of different ways. A basic approach makes use of separately applying each of the text transformation rules to the training text and to compare the transformed training text with the reference text in order to determine whether the text transformation rule has a positive or a negative impact on the error rate of the training text. For example, for each text transformation rule a positive and a negative counter is incremented for elimination or generation of an error due to application of the rule, respectively. Based on these positive and negative counts, an error reduction measure can be derived indicating the overall performance of the text transformation rule with respect to the erroneous text.

A more sophisticated approach to evaluate the plurality of text transformation rules is based on performing an iterative evaluation procedure. The variety of text transformation rules are ranked with respect to e.g. their error reduction measure and only the highest ranked text transformation rule is applied to the erroneous text. Thereafter, the modified erroneous text is repeatedly compared with the reference text in order to generate a second set of text transformation rules. This second set of text transformation rules is also ranked and again the highest ranked rule is applied to the modified training text in order to generate a second modified training text. This procedure is repeatedly performed and allows to evaluate the various text transformation rules with respect to interactions between various rules.

Another approach makes use of arranging various text transformation rules with respect to their common text assignment. This arrangement accounts for partially overlapping rules that apply to e.g. the same type of error. In this way various groups of text transformation rules are generated and for each group of text transformation rules, a single rule, typically that one with the best performance, i.e. that one with the highest ranking, is actually selected. Hence, evaluation of text transformation rules performed in step 110 might be linked to the subsequent step 112 where various text transformation rules are selected for the text correction system.

Once these rules have been selected in step 112 they are provided to the text correction system in step 114 that is adapted to strictly apply these text transformation rules in the selected order. Since the evaluated and selected text transformation rules are specific for systematic errors of the erroneous text or systematic errors of the ASR system or speech to text transformation system that generated the erroneous text, the generated rules can be universally applied either to compensate the systematic errors of an ASR system or to redesign the ASR system. Hence, the inventive method of generating text transformation rules can be universally applied to any commercially available speech to text transformation system. The generated text transformation rules may then either be used by an automatic text correction system that is adapted to correct the systematic errors of the speech to text transcription system or as feedback for improving the speech to text transformation system.

The block diagram illustrated in FIG. 2 shows a reference text 200 and a training text 204 that has erroneous text portions. As an example the reference text has a text portion 202 like “the patient has a severe problem” and the training text 204 has a corresponding erroneous text portion 206 “the patient has weird problem”. By comparing the reference text 200 with the training text 204 the deviations between the two expressions 202, 206 will be detected. This detection of erroneous portions of the training text 204 may be performed by making use of a word to word comparison, a phrase to phrase comparison or a partition of the erroneous text portion 206 into correct and erroneous text regions.

The deviation between the two text elements or text regions 202, 206 might be due to many reasons. Therefore, for the detected deviation a whole set of text transformation rules is generated as illustrated by the table 208. Typically, the text transformation rules specify an erroneous text stored in column 216 that has to be replaced by a correct text that is shown in column 218. Each of these alternative assignments specifies a distinct text transformation rule 210, 212, 214, each of which may have an application condition that is given by the column 220. As described above, the rule 214 which replaces “has weird” by “has a severe” may also be interpreted as a rule like 212 replacing “weird” by “a severe” with the additional condition 220 that the preceding word has to be “has”. In this way, conditions can be automatically extracted from the analysis of surrounding text portions. Similarly, if some higher level segmentation or any kind of tagging is available, this additional information may serve as condition 220.

With respect to the erroneous text element 206 and its correct counterpart 202, various substitutions are conceivable. For example rule 210 may specify that “weird” has to be replaced by “severe”. Rule 212 may specify that the word “weird” has to be replaced by the two words “a severe” and rule 214 may specify that the expression “has weird” has to be replaced by an expression “has a severe”. The generation of these rules 210, 212, 214 is performed irrespective of the content of these rules and irrespective of a potential performance of these rules. For example generally replacing the word “weird” by “severe” is definitely not a good choice because any correct text portion making use of the word “weird” would be subject to a substitution by the word “severe”. Therefore, evaluation and ranking of the variety of generated rules 210, 212, 214 including their associated conditions 220, if any, is required.

FIG. 3 illustrates a flowchart of performing the iterative evaluation procedure. The iterative evaluation procedure makes use of a plurality of text transformation rules that have been detected and generated by means of a comparison of the erroneous training text with the correct reference text. In a first step 300, for each text transformation rule of the set of text transformation rules an error reduction measure is determined. Determination of the error reduction measure can be effectively performed by strictly applying a text transformation rule to the erroneous text and by subsequently comparing the transformed text with the original reference text. In this way, it can be detected whether application of the text transformation rule led to an elimination or to a generation of an error. The occurrence of newly generated errors and eliminated errors is determined by making use of negative and positive counts that allow to derive an error reduction measure for each text transformation rule. This error reduction measure can for example be determined by subtracting the negative counts from the positive counts and therefore indicates whether the particular text transformation rule has an enhancing or a degrading impact on the erroneous training text.

Based on the error reduction measure, the set of text transformation rules can be ranked and re-sorted in the successive step 302. Hence, the variety of text transformation rules may be sorted with respect to their error reduction measure. Typically, those text transformation rules featuring a negative error reduction measure, i.e. those rules that introduce more errors than they eliminate may already be discarded.

After the ranking of the text transformation rules has been performed in step 302 in the successive step 304 the highest ranked text transformation rule is applied to the training text. Application of the highest ranked text transformation rule refers to a strict application of only this particular transformation rule. As a result, the training text will be appropriately modified. Thereafter, in step 306 this transformed training text that is a result of the strict application of the highest ranked transformation rule, is compared with the reference text. This comparison performed in step 306 makes use of the same techniques that have already been applied for the generation of the initial set of text transformation rules. Hence, deviations between the transformed training text and reference text are detected and corresponding text transformation rules are generated.

Based on this comparison performed in step 306, the next set of text transformation rules is generated in the following step 308. Thereafter, in step 310 a stop criterion for the iterative evaluation procedure is checked. The stop criterion may for example specify that after e.g. the tenth iteration the evaluation procedure shall stop. Alternatively, the stop criterion may specify to stop the procedure when in step 308 only a limited number of transformation rules have been generated indicating that transformed training text and reference text almost exactly match. If the stop criterion in step 310 is fulfilled, the procedure will continue with step 312, where the evaluation of the set of text transformation rules stops and where the highest ranked rule of each iteration is selected as text transformation rules that is provided to the text correction system.

In the other case, when the stop criterion is not fulfilled in step 310, the procedure continues with step 314, where the next set of text transformation rules generated by step 308 are separately evaluated. This separate evaluation refers to determine an error reduction measure for each text transformation rule of the next set of text transformation rules as was performed in step 300 for the initial set of text transformation rules. Correspondingly, also a ranking of the next set of text transformation rules is performed on the basis of the error reduction measures of the separate text transformation rules. Thereafter, the procedure returns to step 304, where the highest ranked text transformation rule is applied to the training text.

Preferably, in this repeated execution of step 304 the highest ranked text transformation rule is not applied to the initial training text but to the training text that resulted from the first application of the highest ranked transformation rule of the initial set of text transformation rules.

This iterative procedure of evaluating and selecting text transformation rules allows to account for interactions between various text transformation rules, e.g. when text transformation rules may feature a certain overlap. In this way after application of the best evaluated text transformation rule, the entire procedure of comparing the modified text with the training text, determining a set of text transformation rules and performing an evaluation and ranking of the text transformation rules is repeatedly applied.

FIG. 4 illustrates a block diagram of a rule generation module 400 that is adapted to generate and to evaluate text transformation rules. The rule generation module 400 may interact with an automatic speech recognition system 402 providing erroneous text input into the rule generation module 400. Additionally, the rule generation module 400 is adapted to interact with a text correction system 404 and a user 406. Alternatively, the illustrated rule generation module 400 might be implemented into a text correction system 404 and/or into a speech to text transcription system, such as an ASR 402.

The rule generation module 400 has a storage module 408 that allows to separately store an erroneous text as training text in a training text storage block 422 and to store a correct reference text in the reference text storage block 424. Typically, training text and reference text are stored in different storage blocks of one, reconfigurable storage module 408. The training text as well as reference text are typically provided in electronic form to the rule generation module 400.

The rule generation module 400 further has a comparator module 412, a rule generator 414, a rule storage 416, a display 418, a rule selector 420, a user interface 428 and a rule evaluator 410. Typically, the rule evaluator 410 further has a storage and in particular a temporary storage module 426.

The comparator 412 serves to compare the training text and the reference text in order to find any deviations between reference and training text. This comparison may make use of word to word comparisons and word to word matching between the two texts but is by no means limited to word to word mappings. Moreover, the comparator module 412 is adapted to perform a Levenshtein alignment or to make use of minimum editing distance algorithms in order to find and to classify any deviations of text elements or text regions of the training text and the reference text. The comparator module 412 may make use of phrase to phrase matching and to partition a text into erroneous and non-erroneous regions.

Based on the results of the comparator module 412, the rule generator 414 is adapted to generate at least one rule for each erroneous text region. Typically, the rule generator assigns erroneous text regions with corresponding correct text regions and may further specify an application condition for the assignment. Typically, the rule generator 414 is adapted to generate a set of alternative rules for each detected deviation. This is particularly advantageous to cover a large variety of correction rules that are conceivable and appropriate to eliminate a detected error.

The rule storage module 416 is adapted to store the rules generated by means of the rule generator 414. The rule evaluator 410 is adapted to interact with almost any other component of the rule generation module 400. The rule evaluator serves to apply the rules generated by means of the rule generator 414 to the training text that is stored in the storage block 422. The rule evaluator 410 has a temporary storage module 426 for e.g. storing a modified training text that has been modified due to strict application of a particular rule that has been stored in the rule storage module 416.

Apart from applying this distinct rule and storing the result in the temporary storage module 426, the rule evaluator 410 is further adapted to compare the reference text with the modified training text. Typically, this comparison may be performed by means of the comparator 412. In this way the rule evaluator 410 controls the comparator 412 in order to compare the modified training text with the reference text. The result of this comparison may be provided to the rule evaluator, which in turn may extract and derive an error reduction measure for the applied rule. This error reduction measure may then be submitted to the rule storage module 416 that might be assigned to the corresponding rule.

The rule evaluator 410 is further adapted to perform any of the described rule evaluation procedures. Hence, the rule evaluator is adapted to perform a ranking of the rules stored in the rule storage module 416 and to apply the highest ranked rule to the training text. Thereafter, the rule evaluator 410 may control the comparator 412, the rule generator 414 and the rule storage 416 to generate a second set of text transformation rules on the basis of a comparison between the modified training text and the reference text. With each iteration, only the highest ranked rule may then be submitted to the rule selector 420. Finally, the rule that has been evaluated and selected by means of rule evaluator 410 and rule selector 420 is provided to the text correction system 404 where it may be strictly applied for future applications in the framework of speech to text transformations.

Additionally, the rule evaluator 410 may interact with a display 418 and a user interface 428. Alternatively, the user interface 428 as well as the display 418 may be implemented as external components of the rule generation module 400. In any case, the user 406 may interact with the rule generation module 400 by means of the display 418 and the user interface 428. In this way various rules that are generated by means of the rule generator 414 can be displayed to the user that may in turn select, deselect, sort or discard some of the generated rules manually. The user input is then provided to the rule evaluator and/or to the rule selector 420 in order to extract appropriate rules for the text correction system 404. Furthermore, the user may provide additional rules which have not yet been proposed from the generator module 414. These rules may then be evaluated by the comparator 412 and evaluator 410 and the result may be fed back to the user or may be exploited by the rule selector.

### LIST OF REFERENCE NUMERALS

200 reference text
202 text element
204 training text
206 text element
208 set of text transformation rules
210 text transformation rule
212 text transformation rule
214 text transformation rule
216 erroneous text element
218 correct text element
220 assignment application condition
400 rule generation module
402 automatic speech recognition system
404 text correction system
406 user
408 storage module
410 rule evaluator
412 comparator
414 rule generator
416 rule storage
418 display
420 rule selector
422 training text storage module
424 reference text storage module
426 temporary storage module
428 user interface

1. A method of generating text transformation rules (210, 212, 214) for an automatic text correction by making use of at least one erroneous training text (204) and a corresponding correct reference text (200), the method comprising the steps of:
comparing the at least one erroneous training text with the correct reference text,
deriving a set of text transformation rules (210, 212, 214) by making use of deviations between the training text and the reference text, the deviations being detected by means of the comparison,
evaluating the set of text transformation rules by applying each transformation rule to the training text,
selecting of at least one of the set of evaluated text transformation rules for the automatic text correction.

2. The method according to claim 1, wherein deriving of text transformation rules (210, 212, 214) is performed with respect to assignments between text regions (216, 218) of the training and the reference text, the text regions specifying contiguous and/or non-contiguous phrases and/or single or multiple words and/or numbers and/or punctuation.

3. The method according to claim 1, wherein a text transformation rule (210, 212, 214) comprises at least one assignment between a text region of the training text (216) and a text region of the reference text (218), the text transformation rule further makes use of an application condition (220) specifying situations where the assignment is applicable.

4. The method according to claim 1, wherein evaluating the set of text transformation rules (210, 212, 214) makes use of separately evaluating each text transformation rule of the set of text transformation rules, evaluating of a text transformation rule further making use of an error reduction measure and comprises the steps of:
applying the text transformation rule to the training text (204) in order to generate a transformed training text,
determining a number of positive counts indicating how often application of the text transformation rule provides elimination of an error of the training text,
determining a number of negative counts indicating how often application of the text transformation rule provides generation of an error in the training text,
deriving an error reduction measure for the text transformation rule by making use of the numbers of positive and negative counts.

5. The method according to claim 4, wherein evaluating the set of text transformation rules (210, 212, 214) comprises an iterative evaluation procedure, wherein one iteration comprises the steps of:
performing a ranking of the set of text transformation rules by making use of the error reduction measure,
applying the highest ranked text transformation rule to the training text in order to generate a first transformed training text,
deriving a second set of text transformation rules on the basis of the reference text and the first transformed training text,
and wherein a successive iteration comprises performing a second evaluation and a second ranking of the second set of text transformation rules.

6. The method according to claim 4, wherein evaluating of the set of text transformation rules (210, 212, 214) comprises discarding of a first text transformation rule of a first and a second text transformation rule of the set of text transformation rules, if the first and second text transformation rules substantially refer to the same text region or text regions of the training text, and where the first text transformation rule is discarded if the first text transformation rule is evaluated worse than the second text transformation rule.

7. The method according to claim 1, wherein deriving the set of text transformation rules (210, 212, 214) and/or the application conditions makes use of at least one word class.

8. The method according to claim 1, wherein the text transformation rules (210, 212, 214) further specify conditions to inhibit transformation of correct text regions into erroneous text regions.

9. The method according to claim 1, wherein evaluating and/or selecting of text transformation rules further comprises providing at least some of the set of text transformation rules to a user (406) allowing the user to manually evaluate and/or to manually select the provided text transformation rules (210, 212, 214).

10. The method according to claim 1, wherein user-defined rules are subject to evaluation and wherein the evaluated rules are selected for the automatic text correction and/or are provided to the user for manual selection.

11. The method according to claim 1, wherein the erroneous training text (204) is provided by an automatic speech recognition system (402), a natural language understanding system or a speech to text transformation system.

12. A text correction system (404) making use of text transformation rules (210, 212, 214) for correcting erroneous text, the text correction system being adapted to generate the text transformation rules by making use of at least one erroneous training text (204) and a corresponding correct reference text (200), the text correction system comprising:
means for comparing the at least one erroneous training text with the correct reference text,
means for deriving a set of text transformation rules by making use of deviations between the training text and the reference text, the deviations being detected by means of the comparison,
means for evaluating the set of text transformation rules by applying each transformation rule to the training text,
means for selecting of at least one of the set of evaluated text transformation rules for the text correction system.

13. A computer program product for generating text transformation rules for a text correction system (404), the computer program product being adapted to process at least one erroneous training text (204) and a corresponding correct reference text (200), the computer program product comprising program means being operable to:
compare the at least one erroneous training text with the correct reference text,
derive a set of text transformation rules (210, 212, 214) by making use of deviations between the training text and the reference text, the deviations being detected by means of the comparison,
evaluate the set of text transformation rules by applying each transformation rule to the training text,
select at least one of the set of evaluated text transformation rules for the text correction system.

14. A speech to text transformation system for transcribing speech into text, the speech to text transformation system having a text correction module (404) making use of text transformation rules (210, 212, 214) for correcting errors of the text and having a rule generation module (414) for generating the text transformation rules by making use of at least one erroneous training text being generated by the speech to text transformation system and a corresponding correct reference text, the speech to text transformation system comprising:
a storage module (408) for storing the reference and the training text,
a comparator module (412) for comparing the at least one erroneous training text with the correct reference text,
a transformation rule generator (414) for deriving a set of text transformation rules, the transformation rule generator being adapted to make use of deviations between the training text and the reference text, the deviation being detected by means of the processing module,
an evaluator (410) being adapted to evaluate the set of text transformation rules by applying each transformation rule to the training text,
a selection module (420) for selecting of at least one of the set of evaluated text transformation rules for the text correction module.
